(19) United States
(12) Patent Application Publication
(10) Pub. No.: US 2025/0265139 A1
(43) Pub. Date: Aug. 21, 2025

(54) MISSING DATA IMPUTATION DEVICE AND MISSING DATA IMPUTATION METHOD

(71) Applicant: Hitachi, Ltd., Tokyo (JP)

(72) Inventors: Ken NAONO, Tokyo (JP); Hiroaki MASUDA, Tokyo (JP); Mika TAKATA, Tokyo (JP); Tsunehiko BABA, Tokyo (JP)

(21) Appl. No.: 18/973,505

(22) Filed: Dec. 9, 2024

(30) Foreign Application Priority Data
Feb. 16, 2024 (JP) 2024-022296

(51) Int. Cl. G06F 11/07

(52) U.S. Cl. CPC G06F 11/0772; G06F 11/0727

(57) ABSTRACT

There are provided an imputation priority flagging unit that gives an imputation priority flag to at least one entry falling within a predetermined proportion defined by an imputation amount adjustment parameter in pieces of data of specific column data items, and a priority order determination unit that counts the number of entries each given the imputation priority flag in entries included in a data table, and that determines an integrated imputation priority order in a descending order of the number of the imputation priority flags.

### CROSS REFERENCE TO RELATED APPLICATIONS

This application claims priority based on Japanese patent application No. 2024-022296, filed on Feb. 16, 2024, the entire contents of which are incorporated herein by reference.

### BACKGROUND OF THE INVENTION

### 1. Field of the Invention

The present invention relates to a missing data imputation device and a missing data imputation method. For example, the present invention is applicable to a missing data imputation device associated with a technology for imputing missing data as a preferable application example.

### 2. Description of the Related Art

With recent development of technologies adopting artificial intelligence, studies have been actively conducted concerning machine learning which uses learning data. A part of such learning data contains missing data, in some situations. Accordingly, various studies associated with imputation of missing data have been carried out to deal with these situations. JP-2020-154828-A discloses a technology which imputes missing data as preprocessing of machine learning. The technology disclosed in JP-2020-154828-A is a technology developed to improve imputation accuracy of missing data. Specifically, a correlation matrix calculation unit initially calculates a correlation matrix between attributes by using all learning records. In a case where a missing attribute is present which has a larger absolute value of a correlation value than a correlation threshold, a regression imputation unit performs regression imputation by using the attribute which has the larger absolute value of the correlation value than the correlation threshold.

Patent Literature: JP-2020-154828-A

However, as described above, the technology disclosed in JP-2020-154828-A carries out only regression imputation of missing data, and gives no consideration to the extent to which imputation of missing data is required so as to raise total prediction accuracy of learning data containing the missing data.

The present invention has been developed in consideration of the circumstances described above, and proposes a missing data imputation device and a missing data imputation method each capable of raising total prediction accuracy of learning data containing missing data while more reducing missing data requiring imputation.

### SUMMARY OF THE INVENTION

For solving the problems described above, the present invention includes a data table that includes a plurality of column data items defined in a column direction and a plurality of entries defined in a row direction and each including respective pieces of data of the plurality of column data items, and that contains missing data of each of specific column data items in some of the entries, a parameter definition unit that defines an imputation amount adjustment parameter used for adjustment of a proportion requiring imputation in pieces of data of the specific column data items, a missing data prediction unit that predicts the missing data of each of the specific column data items on the basis of data of each of the column data items other than the specific column data items and on the basis of data of each of the specific column data items in the plurality of entries constituting the data table, an extraction unit that extracts at least one of the entries falling within a predetermined proportion defined by the imputation amount adjustment parameter in the respective pieces of data of the specific column data items, an imputation priority flagging unit that gives an imputation priority flag to the at least one entry falling within the predetermined proportion, and a priority order determination unit that counts the number of the entries each given the imputation priority flag in the entries included in the data table, and determines an integrated imputation priority order in a descending order of the number of the imputation priority flags.

In addition, the present invention includes a parameter definition step that causes a parameter definition unit to define an imputation amount adjustment parameter used for adjustment of a proportion requiring imputation in pieces of data of specific column data items in a data table that includes a plurality of column data items defined in a column direction and a plurality of entries defined in a row direction and each including respective pieces of data of the plurality of column data items, and that contains missing data of each of the specific column data items in some of the entries, a missing data prediction step that causes a missing data prediction unit to predict the missing data of each of the specific column data items on the basis of data of each of the column data items other than the specific column data items and on the basis of data of each of the specific column data items in the plurality of entries constituting the data table, an extraction step that causes an extraction unit to extract at least one of the entries falling within a predetermined proportion defined by the imputation amount adjustment parameter in the respective pieces of data of the specific column data items, an imputation priority flagging step that causes an imputation priority flagging unit to give an imputation priority flag to the at least one entry falling within the predetermined proportion, and a priority order determination step that causes a priority order determination unit to count the number of the entries each given the imputation priority flag in the entries included in the data table, and to determine an integrated imputation priority order in a descending order of the number of the imputation priority flags.

According to the present invention, total prediction accuracy of learning data containing missing data can be raised while missing data requiring imputation is further reduced.

### BRIEF DESCRIPTION OF THE DRAWINGS

FIG. 1 is a system configuration diagram illustrating a configuration example of a missing data imputation device according to a first embodiment;

FIG. 2 is a flowchart illustrating an example of procedures for a missing data imputation process;

FIG. 3 is a flowchart illustrating an example of procedures for a missing data process illustrated in FIG. 2;

FIG. 4 is a diagram illustrating an example of details of a data table;

FIG. 5 is a diagram illustrating an example of the details of the data table;

FIG. 6 is a diagram illustrating an example of the details of the data table;

FIG. 7 is a diagram illustrating an example of the details of the data table;

FIG. 8 is a diagram illustrating an example of the details of the data table;

FIG. 9 is a diagram illustrating an example of the details of the data table;

FIG. 10 is a diagram illustrating an example of the details of the data table; and

FIG. 11 is a diagram illustrating an example of characteristics of total prediction accuracy relative to a data imputation measurement quantity.

### DESCRIPTION OF THE PREFERRED EMBODIMENT

An embodiment according to the present invention will hereinafter be described in detail with reference to the drawings.

An outline of the present embodiment will be initially described upon. In recent years, creation of highly accurate risk prediction models which use various types of data has been promoted. However, at the time of input of a combination of these pieces of data to the risk prediction models, missing data present in the data causes problems, in some situations. Information available for complementing such missing data is individually collected for some of the models, but such information collection requires a huge workload. Meanwhile, for achieving target prediction accuracy of the risk prediction models, collection of information for complementing all pieces of missing data is not necessarily required. For example, if entries indicated by identifiers (IDs) (hereinafter each simply referred to as “entries”) constituting 20 percent of the whole are associated with 80 percent of risks, targeted predictivity can sufficiently be achieved by imputing only missing data of each of these entries constituting 20 percent. Accordingly, the present embodiment gives an imputation priority flag to each of the entries estimated to be associated with 80 percent of the risks, and provides an “integrated imputation priority flag” which indicates an order determined according to the number of the entries each given the imputation priority flag, i.e., according to the number of the imputation priority flags. On the basis of these flags, the present embodiment realizes missing data complementation contributing to high prediction accuracy with a smaller workload. The foregoing points will be hereinafter specifically described.

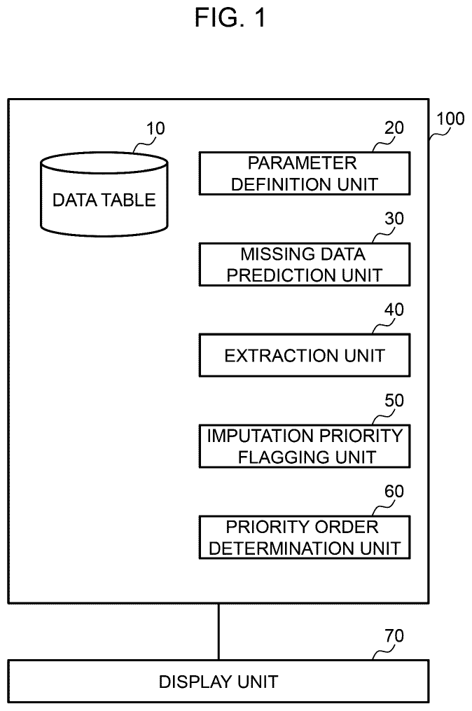

FIG. 1 is a system configuration diagram illustrating a configuration example of a missing data imputation device 100 according to a first embodiment. The missing data imputation device 100 is a computer, for example, and includes a data table 10, a parameter definition unit 20, a missing data prediction unit 30, an extraction unit 40, an imputation priority flagging unit 50, and a priority order determination unit 60. The missing data imputation device 100 preferably includes a display unit 70 as well. Note that the display unit 70 may be formed either integrally with or separately from the missing data imputation device 100.

The data table 10 includes a plurality of column data items defined in a column direction and a plurality of entries defined in a row direction and each including respective pieces of data of the plurality of column data items. The data table 10 contains missing data of each of specific column data items (flood risk and exchange risk) in some of the entries.

The parameter definition unit 20 defines an imputation amount adjustment parameter X. The imputation amount adjustment parameter X herein is a parameter used for adjusting a proportion requiring imputation in pieces of data of specific column data items (e.g., a “flood risk” and an “exchange risk” described below). According to the present embodiment, a predetermined proportion, such as top 30%, or preferably top 70%, is defined as the imputation amount adjustment parameter X.

The missing data prediction unit 30 predicts missing data of each of the specific column data items on the basis of data of each of the column data items other than the specific column data items and on the basis of data of each of the specific column data items in the plurality of entries constituting the data table 10.

For example, the missing data prediction unit 30 learns a model on the basis of an explanatory variable as the data of each of the column data items other than the specific column data items and on the basis of an objective variable as the data of each of the specific column data items in the plurality of entries constituting the data table 10. The missing data prediction unit 30 predicts the missing data of each of the specific column data items through machine learning by using this model.

The extraction unit 40 extracts at least one entry falling within the predetermined proportion defined by the imputation amount adjustment parameter X in the respective pieces of data of the specific column data items.

The imputation priority flagging unit 50 gives an imputation priority flag to the extracted entry described above, i.e., at least one entry falling within the predetermined proportion defined by the imputation amount adjustment parameter X in the data table 10.

The priority order determination unit 60 counts the number of the entries each given the imputation priority flag in the entries included in the data table 10, and determines an integrated imputation priority order in a descending order of the number of the imputation priority flags given to the entries.

The display unit 70 displays list data containing data of each of the specific column data items and the integrated imputation priority order for each of the entries containing missing data. Details of this display will be described below.

The imputation priority flagging unit 50 provides the imputation priority flag for each of a plurality of the foregoing predetermined proportions defined as the imputation amount adjustment parameters (e.g., 30% and 70%). The display unit 70 displays a data imputation measurement quantity based on the list data described above and prediction accuracy associated with the data of each of the specific column data items (e.g., the “flood risk” and the “exchange risk” described below) and obtained by the missing data prediction unit 30.

Subsequently described will be a missing data imputation method as an operation example of the missing data imputation device 100 configured as above. This missing data imputation method includes: a parameter definition step that causes the parameter definition unit 20 to define the imputation amount adjustment parameter X used for adjustment of a proportion requiring imputation in pieces of data of specific column data items in the data table 10 that includes a plurality of column data items defined in a column direction and a plurality of entries defined in a row direction and each including respective pieces of data of the plurality of column data items and that contains missing data of each of the specific column data items in some of the entries; a missing data prediction step that causes the missing data prediction unit 30 to predict the missing data of each of the specific column data items on the basis of data of each of the column data items other than the specific column data items and on the basis of data of each of the specific column data items (e.g., pieces of data excluding missing data) in the plurality of entries constituting the data table 10; an extraction step that causes the extraction unit 40 to extract at least one of the entries falling within a predetermined proportion defined by the imputation amount adjustment parameter X in the respective pieces of data of the specific column data items; an imputation priority flagging step that causes the imputation priority flagging unit 50 to give an imputation priority flag to the at least one entry falling within the predetermined proportion; and a priority order determination step that causes the priority order determination unit 60 to count the number of the entries each given the imputation priority flag in the entries included in the data table 10 and to determine an integrated imputation priority order in a descending order of the number of the imputation priority flags.

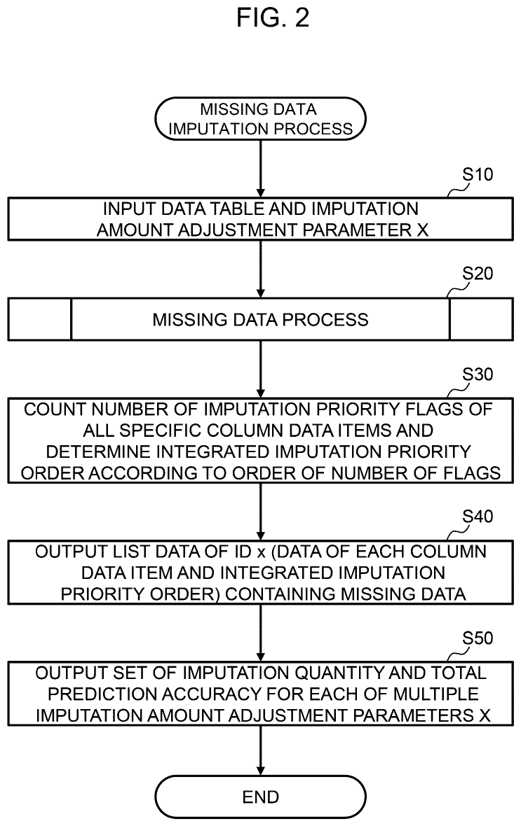

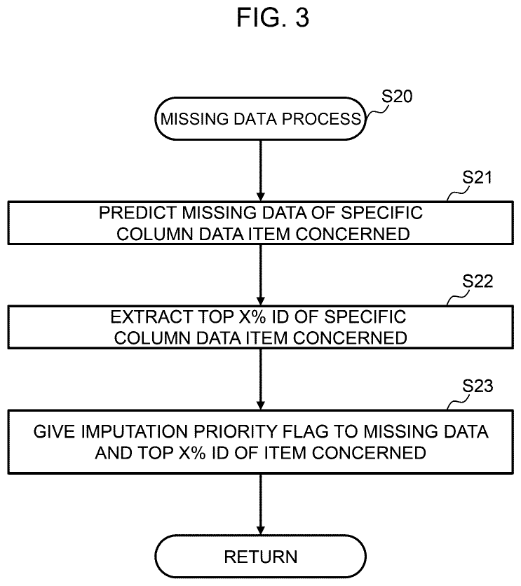

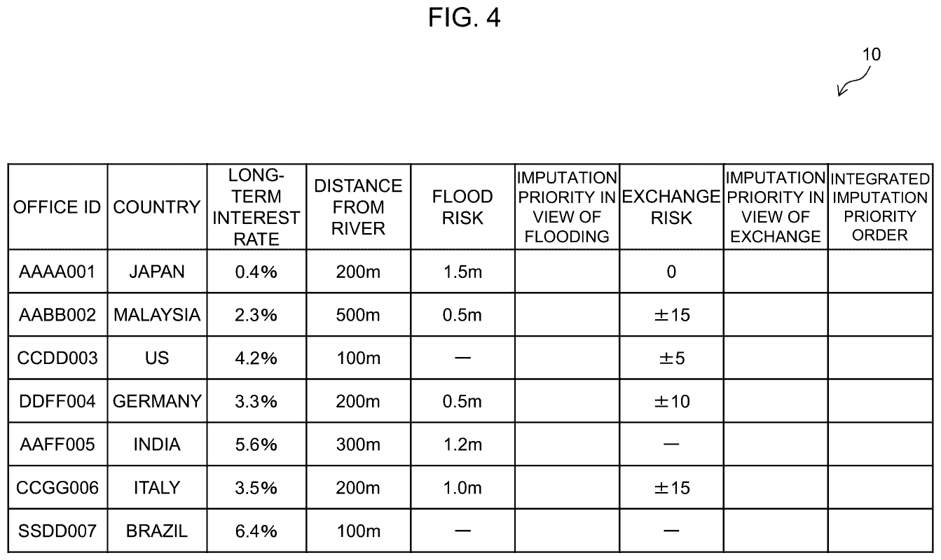

FIG. 2 is a flowchart illustrating an example of procedures for the missing data imputation process, and FIG. 3 is a flowchart illustrating an example of procedures for a missing data process illustrated in FIG. 2 (step S20 in FIG. 2). Description will be hereinafter presented with reference to the data table 10 illustrated in FIGS. 4 to 9.

In step S10 in FIG. 2, the data table 10 and the imputation amount adjustment parameter X are input to the missing data imputation device 100. The parameter definition unit 20 sets a proportion of processing to top 30%, for example, on the basis of the input imputation amount adjustment parameter X.

Meanwhile, for example, the data table 10 defines column data items such as an office ID, a country, a long-term interest rate, a distance from a river, a flood risk, an imputation priority in view of flooding, an exchange risk, an imputation priority in view of exchange, and an integrated imputation priority order, as illustrated in FIG. 4. The data table 10 includes respective pieces of data for these column data items, and manages entries identifiable from each other on the basis of the office ID described above. For example, the data table 10 illustrated in FIG. 4 contains missing data expressed as “-” for the flood risk and the exchange risk as examples of the specific column data items.

In step S20, the missing data process is executed. This missing data process is carried out by the missing data prediction unit 30. In step S21 in FIG. 3, the missing data prediction unit 30 predicts data of each of these specific column data items (a missing value expressed as “−” in the figure).

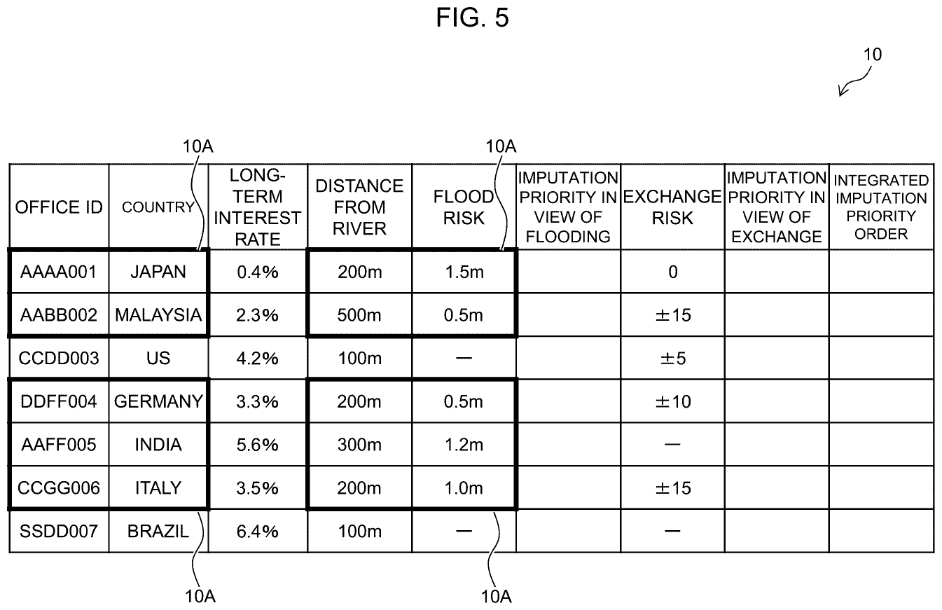

Specifically, in the case of the flood risk, for example, the missing data prediction unit 30 creates a model for predicting the specific column data item containing missing data, such as data of the flood risk, on the basis of a combination of the entries containing no missing data. For example, the combination of the entries containing no missing data herein refers to the entries of the office IDs “AAAA001,” “AABB002,” “DDFF004,” “AAFF005,” and “CCGG006,” indicated by bold lines 10A in FIG. 5. It is assumed in the present embodiment that the flood risk=S is influenced by the country and the distance from the river. Note that these two items (the country and the distance from the river) are explanatory variables and that the flood risk is an objective variable in the present embodiment.

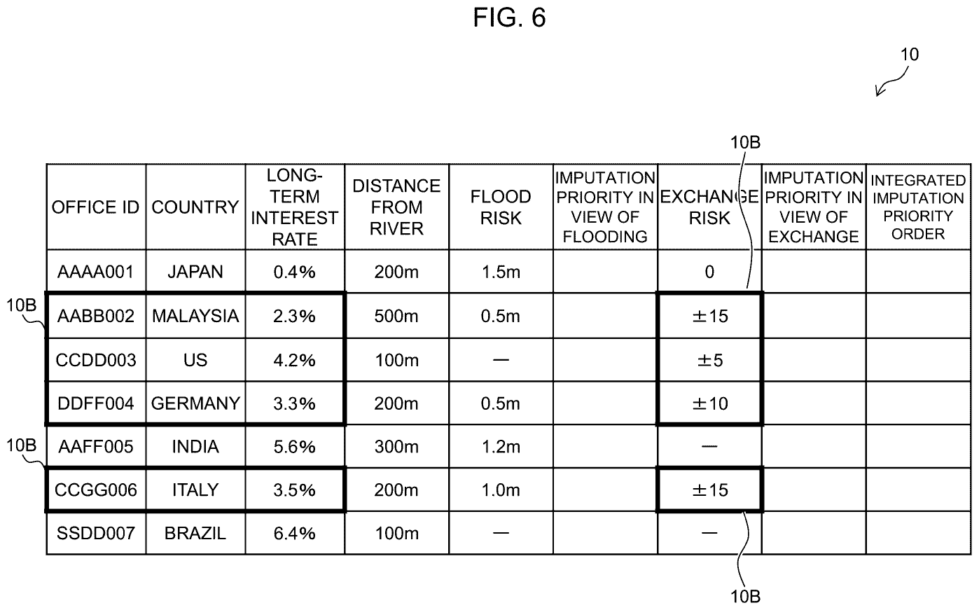

Meanwhile, in the case of the exchange risk, for example, the missing data prediction unit 30 creates a model for predicting the specific column data item containing missing data, for example, data of the exchange risk, on the basis of a combination of the entries containing no missing data. For example, the combination of the entries containing no missing data herein refers to the entries of the office IDs “AAAA002,” “CCDD003,” “DDFF004,” and “CCGG006,” indicated by bold lines 10B in FIG. 6. It is assumed in the present embodiment that the exchange risk=K is influenced by the long-term interest rate of the country. Note that this item (the long-term interest rate of the country) is an explanatory variable and that the exchange risk is an objective variable in the present embodiment.

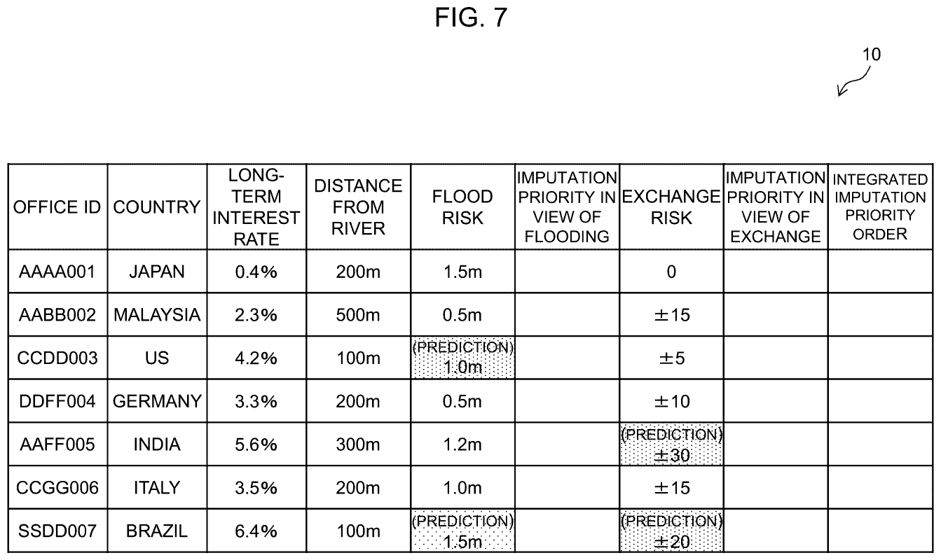

For example, the missing data prediction unit 30 learns a model on the basis of an explanatory variable as the data of each of the column data items other than the specific column data items and on the basis of an objective variable as the data of each of the specific column data items (e.g., flood risk and exchange risk) in the plurality of entries constituting the data table 10, and predicts missing data of each of the specific column data items through machine learning by using this model (corresponding to parts of “prediction” in FIG. 7).

In step S22 in FIG. 3, the extraction unit 40 extracts at least one entry falling within the predetermined proportion (e.g., top 30%) defined by the imputation amount adjustment parameter X in the respective pieces of data of the specific column data items (e.g., flood risk and exchange risk).

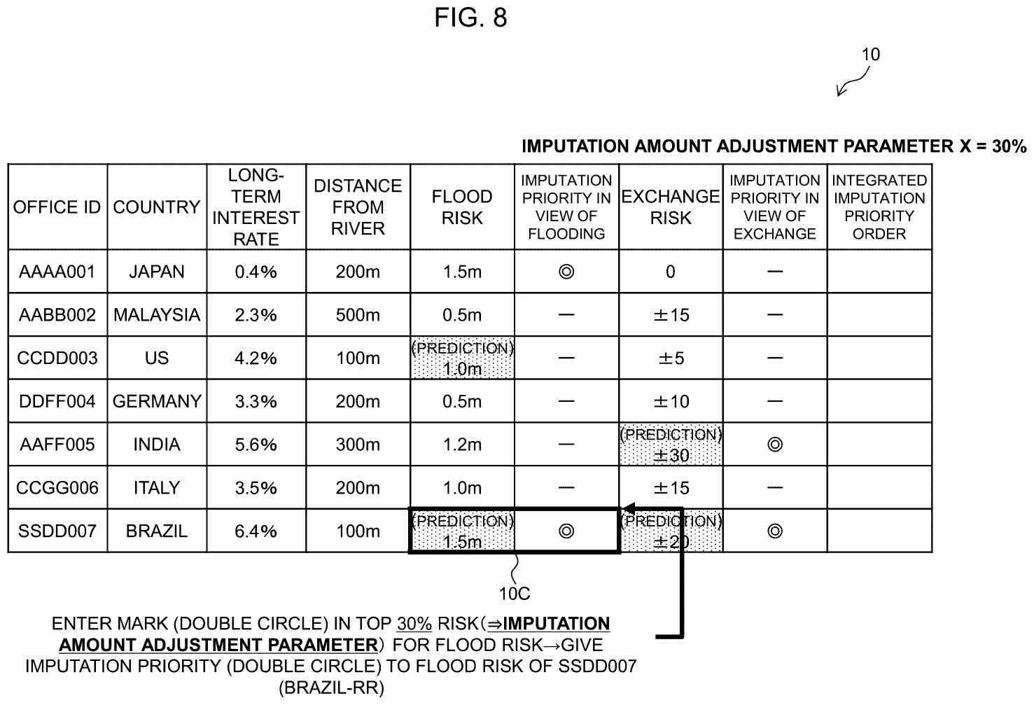

In step S23 in FIG. 3, the imputation priority flagging unit 50 gives an imputation priority flag to at least one entry falling within the predetermined proportion (e.g., top 30%) defined by the imputation amount adjustment parameter X (see FIG. 8). Note that a double circle is entered in each entry to which the imputation priority flag has been given in the example illustrated in the figure.

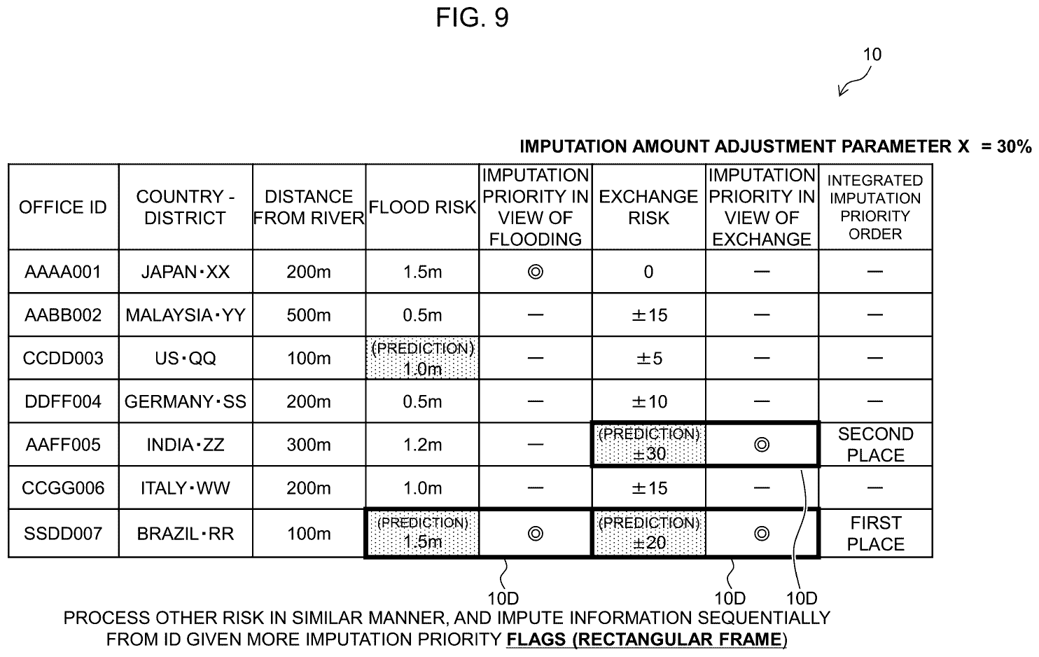

In subsequent step S30 in FIG. 2, the priority order determination unit 60 counts the number of the entries each given the imputation priority flag in the entries included in the data table 10, and determines an integrated imputation priority order in a descending order of the number of the imputation priority flags (see FIG. 9).

In step S40, the display unit 70 displays list data of the entry x containing missing data (data of each column data item and integrated imputation priority order).

In step S50, the display unit 70 displays a set of an imputation quantity and total prediction accuracy for each of a plurality of the imputation amount adjustment parameters X.

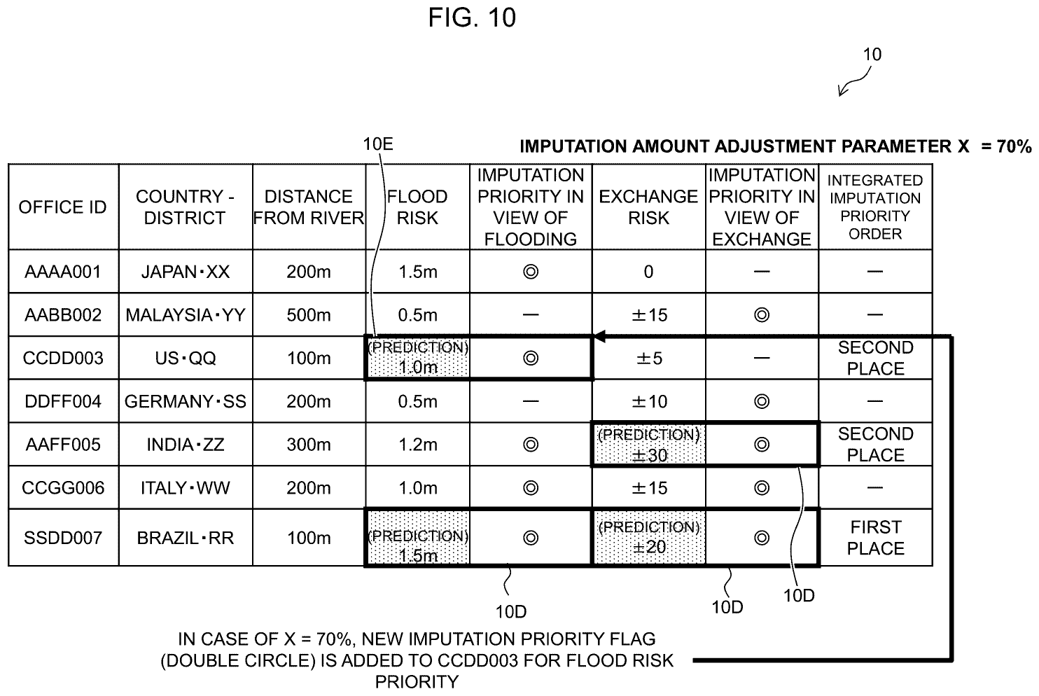

FIG. 10 is a diagram illustrating an example of the missing data imputation process performed under the imputation amount adjustment parameter X of 70%. In the description of the example illustrated in FIG. 10, points similar to the corresponding points described above in the example illustrated in FIGS. 8 and 9 will not be repeatedly explained.

The imputation amount adjustment parameter X in the example illustrated in FIG. 10 is set to 70%. The extraction unit 40 extracts at least one entry falling within a range of top 70% in respective pieces of data of specific column data items (e.g., flood risk and exchange risk).

The imputation priority flagging unit 50 gives an imputation priority flag not only to data 10D extracted in FIG. 9 described above, but also to data 10E of the flood risk associated with the entry of the office ID “CCDD003” (corresponding to the double circle for the imputation priority of the flood risk in the figure).

The priority order determination unit 60 counts the number of the entries each given the imputation priority flag in the entries included in the data table 10, and determines an integrated imputation priority order in a descending order of the number of the imputation priority flags. As a result, the integrated imputation priority order is determined as follows. The entry of the office ID “SSDD007” having two double circles holds the first place, the entry of the office ID “CCDD003” having one double circle holds the second place, and the entry of the office ID “AAFF005” having one double circle holds the third place. Accordingly, the example illustrated in FIG. 10 is different from the example illustrated in FIG. 9 in that the entry of the office ID “CCDD003” is also covered.

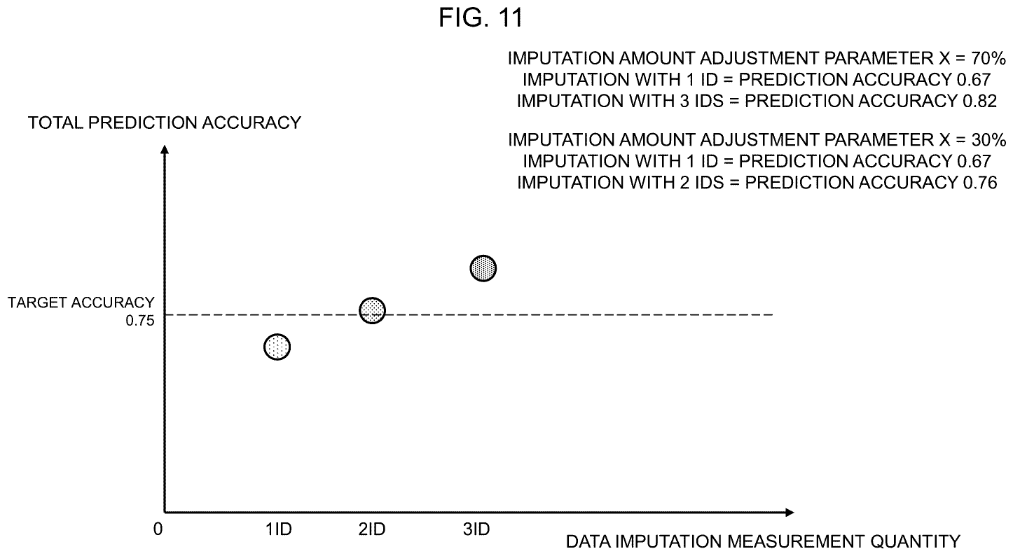

FIG. 11 is a diagram illustrating an example of characteristics of total prediction accuracy relative to a data imputation measurement quantity. The example illustrated in the figure indicates a case in which the imputation amount adjustment parameter X is set to 70% and a case in which the imputation amount adjustment parameter X is set to 30%, in a state where targeted prediction accuracy (corresponding to “target accuracy” in the figure) is 0.75. According to the example illustrated in the figure, “1 ID” in the figure indicates imputation using an entry corresponding to one office ID (hereinafter also referred to as “1 ID imputation”), “2 IDs” indicates imputation using entries corresponding to two office IDs (hereinafter also referred to as “2 ID imputation”), and “3 IDs” indicates imputation using entries corresponding to three office IDs (hereinafter also referred to as “3 ID imputation”).

It is intended in this example that the number of entries corresponding to the office ID requiring imputation is determined in consideration of the target accuracy described above. According to the present embodiment, the missing data prediction unit 30 examines which value is to be set as the value of the imputation amount adjustment parameter X (30% or 70% herein) so as to obtain prediction accuracy of “0.75” as one example of target accuracy. In other words, the missing data prediction unit 30 selects, from a plurality of predetermined proportions each defined as the imputation amount adjustment parameter X (e.g., 30% and 70%), one predetermined proportion appropriate for obtaining sufficient total prediction accuracy of learning data containing missing data for meeting the target accuracy.

The example illustrated in the figure is characterized in that the data imputation measurement quantity increases in the order of “1 ID,” “2 IDs,” and “3 IDs” and that the total prediction accuracy improves according to the increase in the data imputation measurement quantity. For example, the prediction accuracy of “2 IDs” is 0.76, the prediction accuracy of “1 ID” is lower than 0.75 (e.g., 0.67), and the prediction accuracy of “3 IDs” exceeds 0.75 (e.g., 0.82).

According to the present embodiment, for obtaining prediction accuracy reliably reaching the target accuracy of “0.75” described above under the imputation amount adjustment parameter X of 30%, 2 ID imputation is selected instead of 1 ID imputation which does not provide sufficient prediction accuracy.

Meanwhile, for obtaining prediction accuracy reliably reaching the target accuracy of “0.75” described above under the imputation amount adjustment parameter X of 70% in the present embodiment, 3 ID imputation is selected instead of 1 ID imputation which does not provide sufficient prediction accuracy.

As described above, the missing data prediction unit 30 sets the imputation amount parameter X to a value sufficient for obtaining prediction accuracy corresponding to the target accuracy “0.75” described above. In this manner, the missing data prediction unit 30 can raise total prediction accuracy of learning data containing missing data by using the model described above.

As described above, the missing data imputation device 100 according to the present embodiment includes: the data table 10 that includes a plurality of column data items defined in a column direction and a plurality of entries defined in a row direction and each including respective pieces of data of the plurality of column data items and that contains missing data of each of specific column data items (e.g., flood risk and exchange risk) in some of the entries; the parameter definition unit 20 that defines the imputation amount adjustment parameter X used for adjustment of a proportion requiring imputation in pieces of data of the specific column data items; the missing data prediction unit 30 that predicts the missing data of each of the specific column data items on the basis of data of each of the column data items other than the specific column data items and on the basis of data of each of the specific column data items in the plurality of entries constituting the data table 10; the extraction unit 40 that extracts at least one of the entries falling within a predetermined proportion (e.g., 30%) defined by the imputation amount adjustment parameter X in the respective pieces of data of the specific column data items; the imputation priority flagging unit 50 that gives an imputation priority flag to the at least one entry falling within the predetermined proportion; and the priority order determination unit 60 that counts the number of the entries each given the imputation priority flag in the entries included in the data table 10, and determines an integrated imputation priority order in a descending order of the number of the imputation priority flags.

As described above, at least one entry falling within the predetermined proportion defined by the imputation amount adjustment parameter X is extracted by the extraction unit 40, and the imputation priority flag is given to the extracted entry to determine the integrated imputation priority order in a descending order of the number of the imputation priority flags. In this case, missing data deeply influencing prediction accuracy is precisely recognizable with reference to the integrated imputation priority order. Accordingly, total prediction accuracy of learning data containing missing data can be raised while missing data requiring imputation is further reduced.

The missing data imputation device 100 according to the present embodiment includes the display unit 70 which displays list data containing the data of each of the specific column data items and the integrated imputation priority order for each of the entries containing missing data. With reference to the list data containing the data of each of the specific column data items and the integrated imputation priority order for each of the entries containing missing data in this configuration, total prediction accuracy of learning data containing missing data can be raised while missing data requiring imputation is further reduced.

According to the present embodiment, the imputation priority flagging unit 50 provides imputation priority flags for each of a plurality of predetermined proportions (e.g., 30% and 70%) defined as the imputation amount parameters X, while the display unit 70 displays a data imputation measurement quantity based on the list data, and prediction accuracy associated with data of each of the specific column data items and obtained by the missing data prediction unit 30. With reference to the data imputation measurement quantity based on the list data and the prediction accuracy associated with the data of each of the specific column data items and obtained by the missing data prediction unit 30 in this configuration, total prediction accuracy of learning data containing missing data can be raised while missing data requiring imputation is further reduced.

According to the present embodiment, the missing data prediction unit 30 selects, from a plurality of predetermined proportions each defined as the imputation amount adjustment parameter X, one predetermined proportion appropriate for obtaining sufficient total prediction accuracy of learning data containing missing data for meeting the target accuracy. In this manner, total prediction accuracy of learning data containing missing data can be raised to target accuracy or higher while missing data requiring imputation is further reduced.

According to the present embodiment, the missing data prediction unit 30 learns a model on the basis of an explanatory variable as data of each of the column data items other than specific column data items in a plurality of entries constituting the data table 10 and on the basis of an objective variable as data of each of the specific column data items (e.g., the flood risk and the exchange risk described above), and predicts missing data of each of the specific column data items through machine learning by using this model. In this manner, the missing data prediction unit 30 can predict missing data by using the model, in a state in which total prediction accuracy of learning data containing missing data is enhanced while further reduction of missing data requiring imputation is achieved.

Note that the present invention is not limited to the embodiment described above and includes various modifications and equivalent configurations within the scope of the appended claims. For example, the above embodiment has been explained in detail for easy understanding of the present invention. Accordingly, the present invention is not necessarily required to be equipped with all the configurations described above. In addition, elements presented in parallel in the description of the present embodiment may be configured such that at least one of the elements is connected to another element or the other elements in series.

The present invention is applicable to a missing data imputation device associated with a technology for imputing missing data.

What is claimed is:

1. A missing data imputation device comprising:
a data table that includes a plurality of column data items defined in a column direction and a plurality of entries defined in a row direction and each including respective pieces of data of the plurality of column data items, and that contains missing data of each of specific column data items in some of the entries;
a parameter definition unit that defines an imputation amount adjustment parameter used for adjustment of a proportion requiring imputation in pieces of data of the specific column data items;
a missing data prediction unit that predicts the missing data of each of the specific column data items on a basis of data of each of the column data items other than the specific column data items and on a basis of data of each of the specific column data items in the plurality of entries constituting the data table;
an extraction unit that extracts at least one of the entries falling within a predetermined proportion defined by the imputation amount adjustment parameter in the respective pieces of data of the specific column data items;
an imputation priority flagging unit that gives an imputation priority flag to the at least one entry falling within the predetermined proportion; and
a priority order determination unit that counts the number of the entries each given the imputation priority flag in the entries included in the data table, and determines an integrated imputation priority order in a descending order of the number of the imputation priority flags.

2. The missing data imputation device according to claim 1, further comprising:
a display unit that displays list data containing the data of each of the specific column data items and the integrated imputation priority order for each of the entries containing the missing data.

3. The missing data imputation device according to claim 2, wherein
the imputation priority flagging unit gives the imputation priority flag to each of a plurality of the predetermined proportions defined as the imputation amount adjustment parameters, and
the display unit displays a data imputation measurement quantity based on the list data, and prediction accuracy associated with the data of each of the specific column data items and obtained by the missing data prediction unit.

4. The missing data imputation device according to claim 3, wherein
the missing data prediction unit selects, from a plurality of the predetermined proportions defined as the imputation amount adjustment parameters, one predetermined proportion appropriate for obtaining sufficient total prediction accuracy of learning data containing the missing data for meeting target accuracy.

5. The missing data imputation device according to claim 1, wherein
the missing data prediction unit learns a model on a basis of an explanatory variable as the data of each of the column data items other than the specific column data items and on a basis of an objective variable as the data of each of the specific column data items in the plurality of entries constituting the data table, and predicts the missing data of each of the specific column data items through machine learning by using the model.

6. A missing data imputation method comprising:
a parameter definition step that causes a parameter definition unit to define an imputation amount adjustment parameter used for adjustment of a proportion requiring imputation in pieces of data of specific column data items in a data table that includes a plurality of column data items defined in a column direction and a plurality of entries defined in a row direction and each including respective pieces of data of the plurality of column data items, and that contains missing data of each of the specific column data items in some of the entries;
a missing data prediction step that causes a missing data prediction unit to predict the missing data of each of the specific column data items on a basis of data of each of the column data items other than the specific column data items and on a basis of data of each of the specific column data items in the plurality of entries constituting the data table;
an extraction step that causes an extraction unit to extract at least one of the entries falling within a predetermined proportion defined by the imputation amount adjustment parameter in the respective pieces of data of the specific column data items;
an imputation priority flagging step that causes an imputation priority flagging unit to give an imputation priority flag to the at least one entry falling within the predetermined proportion; and
a priority order determination step that causes a priority order determination unit to count the number of the entries each given the imputation priority flag in the entries included in the data table, and to determine an integrated imputation priority order in a descending order of the number of the imputation priority flags.

7. The missing data imputation method according to claim 6, further comprising:
a display step that causes a display unit to display list data containing the data of each of the specific column data items and the integrated imputation priority order for each of the entries containing the missing data.

8. The missing data imputation method according to claim 7, wherein
the imputation priority flagging unit gives the imputation priority flag to each of a plurality of values defined as the imputation amount adjustment parameters, and
the display step causes the display unit to display a data imputation measurement quantity based on the list data, and prediction accuracy associated with the data of each of the specific column data items and obtained by the missing data prediction unit.

9. The missing data imputation method according to claim 8, wherein
the missing data prediction step causes the missing data prediction unit to select, from a plurality of the predetermined proportions defined as the imputation amount adjustment parameters, one predetermined proportion appropriate for obtaining sufficient total prediction accuracy of learning data containing the missing data for meeting target accuracy.

10. The missing data imputation method according to claim 6, wherein
the missing data prediction step causes the missing data prediction unit to learn a model on a basis of an explanatory variable as the data of each of the column data items other than the specific column data items and on a basis of an objective variable as the data of each of the specific column data items in the plurality of entries constituting the data table, and to predict the missing data of each of the specific column data items through machine learning by using the model.
